(19) United States
(12) Patent Application Publication
(10) Pub. No.: US 2007/0133020 A1
(43) Pub. Date: Jun. 14, 2007

(54) Image processing system and image processing method

(75) Inventors: Hiroyoshi Uejo, Kanagawa (JP); Toru Misaizu, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/447,988

(22) Filed: Jun. 7, 2006

(30) Foreign Application Priority Data
Dec. 14, 2005 (JP) 2005-360487

(51) Int. Cl. H04N 1/60

(52) U.S. Cl. 358/1.9

(57) ABSTRACT

An image processing system performing image processing on input image data includes an accepting part that accepts selection of a machine recognition processing mode intended for outputting a print image on the assumption that the image, after being output, is subjected to machine recognition processing, and a processing part that performs specific image processing adapted for the machine recognition processing instead of normal image processing, when the selection of the machine recognition processing mode has been accepted by the accepting part.

### CROSS-REFERENCE TO RELATED APPLICATION

This application claims priority under 35 USC 119 from Japanese patent application No. 2005-360487 filed on Dec. 14, 2005, the disclosure of which is incorporated by reference herein.

### BACKGROUND

1. Technical Field

The present invention relates to an image processing system that performs image processing on a document created by a host computer or the like for print output by an image forming apparatus and an image processing method.

2. Related Art

As a conventional technique that reads a print sample by a scanner (image input terminal) and encodes a raster image, an Optical Character Reader (OCR) exists. This OCR optically reads handwritten characters and/or printed characters with the scanner, compares each character to patterns stored in memory beforehand for a match to determine character information, and supplies the characters as input data (character data).

With the current OCR technology, it is not practicable to perform 100-percent encoding of character information in a document and there are various kinds of images that cannot be encoded well. Images that may not be good for OCR are, for example, a document including line art, light-color characters, low-resolution characters, etc.

Meanwhile, one may think that original documents should be encoded in electronic form and electronic documents can be transferred without being output (printed out) to paper and without being processed by the OCR. However, for example, there is a case where some law or the like of Japan concerning electronic documents (e.g., Electronic Document Law) requires originals in both paper form and electronic form. In the present situation, the culture persists in which originals written or printed on paper are valid for use, for example, a request form for transportation expense, affixing a bill of receipt with tally impression, and the like. In consequence, there is still a strong need for reading characters present on paper and inputting character data and the requirement for OCR processing on printed pages is very high.

### SUMMARY

According to an aspect of the present invention, an image processing system performing image processing on input image data includes an accepting part that accepts selection of a machine recognition processing mode intended for outputting a print image on the assumption that the image, after being output, is subjected to machine recognition processing, and a processing part that performs specific image processing adapted for the machine recognition processing instead of normal image processing, when the selection of the machine recognition processing mode has been accepted by the accepting part.

### BRIEF DESCRIPTION OF THE DRAWINGS

The above and other aspects, features, and advantages of the present invention will be more apparent from the following description of an exemplary embodiment thereof, taken in conjunction with the accompanying drawings, wherein:

FIG. 1 shows an overall structure of a printer system to which a first exemplary embodiment of the invention is applied;

FIG. 2 is a block diagram showing a functional structure of the printer system to which the first exemplary embodiment is applied;

FIG. 3 is a flowchart illustrating processing in OCR mode which is performed in the printer system of the first exemplary embodiment;

FIG. 4 shows an example of object separation from drawing commands described in a PostScript language;

FIGS. 5A and 5B show examples of processing of each object according to tag; and

FIG. 6 is a flowchart illustrating the flow of processing in OCR mode in a second exemplary embodiment of the invention.

### DETAILED DESCRIPTION

Exemplary embodiments of the present invention will be described in detail hereinafter with reference to the drawings.

### FIRST EXEMPLARY EMBODIMENT

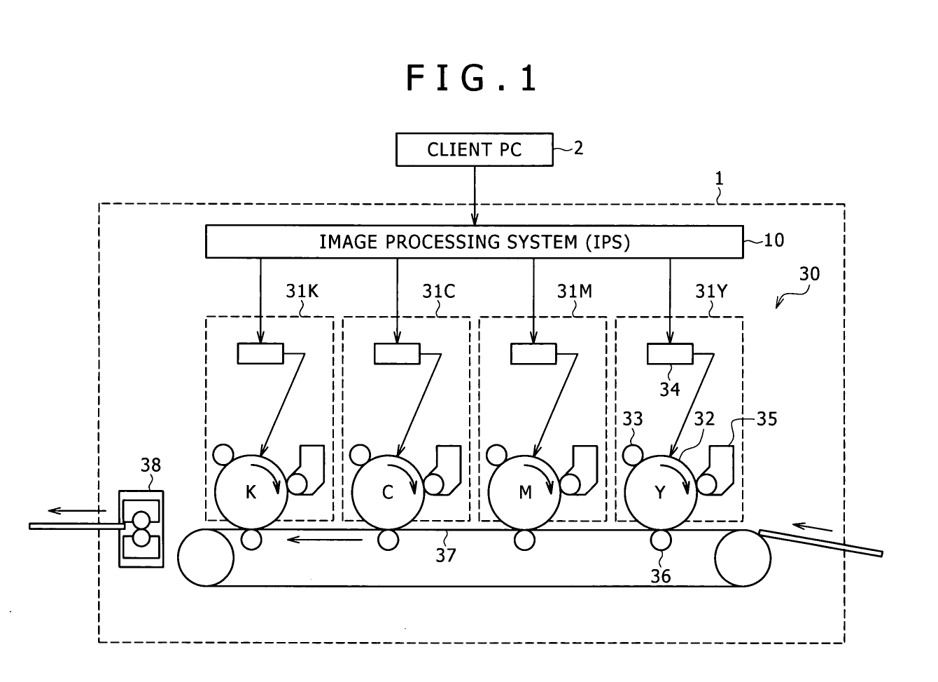

FIG. 1 shows an overall structure of a printer system to which a first exemplary embodiment of the invention is applied. Here, an image forming apparatus 1 that decodes input data for an electronic document into an image and prints the image on paper and a client PC (personal computer) 2 that is a host computer which provides an electronic document to the image forming apparatus 1 are shown. To this image forming apparatus 1, image data may be supplied from an image input terminal (IIT), which is not shown, other than the client PC 2. The image data may also be supplied from a scanner, a facsimile machine, a digital still camera, and so forth. The image forming apparatus I outputs (prints out) a print image to be processed by an OCR (Optical Character Reader).

This image forming apparatus 1 includes an image processing system (IPS) 10 that performs image processing as defined herein on image data of an electronic document which has been output from, for example, the client PC 2, and a marking engine 30 that is a so-called tandem type digital color printer using an electrophotographic system. The marking engine 30 includes image forming units 31Y, 31M, 31C, 31K, which correspond to multiple engines, arranged in parallel, regularly spaced in a horizontal direction. These image forming units, respectively, form toner images of yellow (Y), magenta (M), cyan (C), and black (K) and transfer the toner images in order onto a sheet of paper. Each of these four image forming units 31 Y, 31 M, 31 C, 31 K includes a photoconductor drum 32 that is an image carrier (photoconductor) on which an electrostatic latent image is formed and a toner image is carried, a charging device 33 that charges the surface of the photoconductor drum 32 uniformly, an exposure device 34 that illuminates the photoconductor drum 32 uniformly charged by the charging device 33, and a development device 35 that develops an electrostatic latent image produced by the exposure device 34. Each image forming unit also includes a transfer roller 36 that transfers the toner image formed on the surface of the photoconductor drum 32 onto a sheet of paper. The marking engine 30 also includes a paper transport belt 37 for transporting a sheet of paper to pass transfer positions which are formed between the photoconductor drum 32 and the transfer roller 36 of each image forming unit 31Y, 31M, 31C, 31K. It also includes a fixing device 38 that fixes the toner image transferred to the sheet of paper.

Image data which has been input from the client PC 2 undergoes image processing by the image processing system 10 and is fed to the marking engine 30 via a predetermined interface. The components of the marking engine 30 operate based on control signals such as sync signals supplied from an image output controller which is not shown. First, the image forming unit 31Y for yellow (Y) forms an electrostatic latent image on the surface of the photoconductor drum 32 charged by the charging device 33, based on an image signal received from the image processing system 10. This latent image is formed by illumination by the exposure device 34. A yellow (Y) toner image is developed from the electrostatic latent image by the development device 35. The formed yellow (Y) toner image is transferred onto a sheet of paper on the paper transport belt 37 which rotates in the arrow direction shown, using the transfer roller 36. Likewise, magenta (M), cyan (C), and black (K) toner images are formed on the respective photoconductor drums 32 and sequentially transferred so as to be superposed on top of the toner image formed on the sheet of paper on the paper transport belt 37, using the transfer rollers 36. A composite toner image thus produced on the sheet of paper is transported to the fixing device 38 and fixed to the paper by application of heat and pressure.

Next, an image processing method to which the first exemplary embodiment is applied is described.

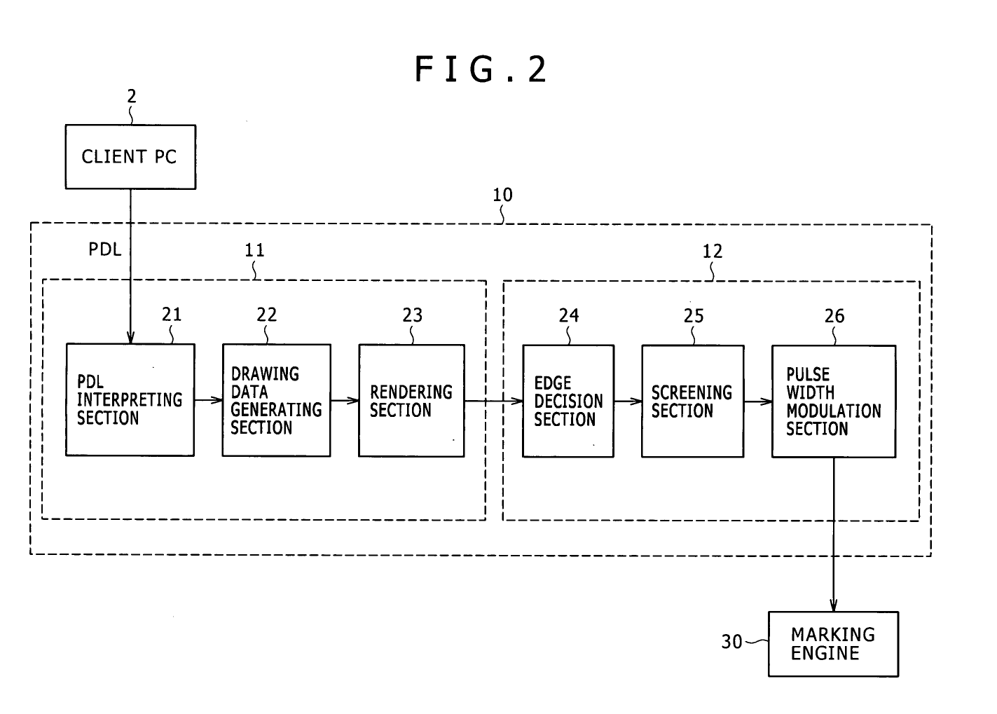

FIG. 2 is a block diagram showing a functional structure of the printer system to which the first exemplary embodiment is applied. The image processing system 10 primarily includes a controller 11 and an engine controller 12. The controller 11 includes a PDL interpreting section 21 that interprets Page Description Language (PDL) commands sent from the client PC 2 and a drawing data generating section 22 that converts color signals (RGB) specified in PDL into color signals (YMCK) for the marking engine 30. The controller 11 also includes a rendering section 23 that renders intermediate codes of drawing data created by the drawing data generating section 22 into image data adapted for the marking engine 30.

On the other hand, the engine controller 12 includes an edge decision section 24 that makes an edge decision on rendered image data and a screening section 25 that performs screening (binarization) on the image data for which the edge decision has been made. The engine controller 12 also includes a pulse width modulation section 26 that performs pulse width modulation on the image data screened by the screening section 25. The image data, pulse-width modulated by the pulse width modulation section 26 is output to the marking engine 30.

Here, in the present exemplary embodiment, a specific mode (machine recognition mode) termed “OCR mode” can be set, when the image forming apparatus 1 is to print out an image that is subjected to machine recognition such as OCR. In the OCR mode, image manipulation (image enhancement) is carried out on an image to be printed out, so that the printed image can be successfully encoded by the OCR. This image manipulation may be performed within the image forming apparatus 1 or performed by the client PC 2. In one form of implementation, the image forming apparatus 1 may be arranged to present an interface allowing for selection by the user on a control panel (not shown) and the user can enter or specify OCR mode via this interface. In another form of implementation, for example, an application for print output that runs on the client PC 2 may be configured to provide an OCR mode option as one of print output instructions. When the OCR mode option is selected during the run of the application, the client PC recognizes it and switches to the OCR mode.

As an instance where the OCR mode is used, for example, a request form for transportation expense payments is printed out. An image of this form in which the amount of transportation expenses is written in a given area is printed out and, for example, a bill of receipt is pasted to a space in the printed sheet of the form. In order that the OCR will read only the amount of transportation expenses on the printed sheet of the form, printing in the OCR mode is performed, thereby allowing the OCR to read it successfully. Other instances where the OCR mode is used are, for example, printing a tax payment form and a statement of accounts, printing e-mail addresses and URLs, and the like. Using the OCR mode can have wide application.

Next, processing in the above OCR mode is described in detail.

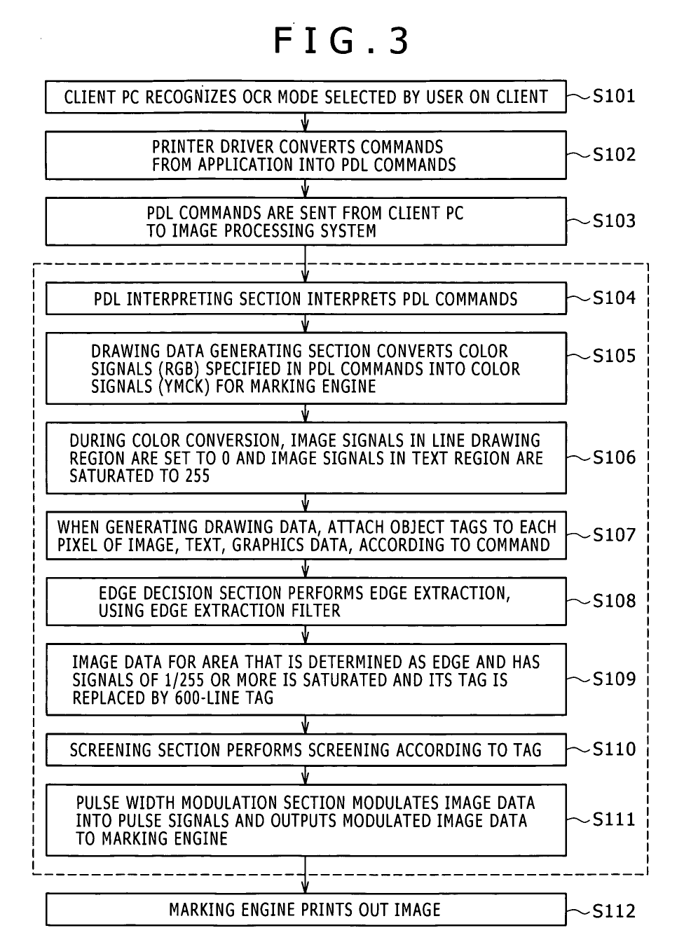

FIG. 3 is a flowchart illustrating processing in the OCR mode which is performed in the printer system of the first exemplary embodiment. Steps 101 through 103 are executed by the client PC 2 and steps 104 through 111 are executed by the image processing system 10.

First, for example, the client PC 2 recognizes OCR mode selected by the user on the client (step 101). A printer driver converts commands from an application into PDL (Page Description Language) commands which are drawing commands to be interpreted by the printer (step 102). PDL drawing commands generated by the conversion by this printer driver are sent from the client PC 2 to the image processing system 10 (step 103).

In the image processing system 10, the PDL interpreting section 21 interprets the received PDL commands (step 104). Then, the drawing data generating section 22 converts color signals (RGB) specified in the interpreted PDL commands into color signals (YMCK) for the marking engine 30 (step 105). Here, during the color conversion, when the OCR mode is selected in the step 101, the image signals in a line drawing region which is drawn by a line drawing command are set to 0 and the image signals in a text region are saturated to 255 (step 106). When drawing data is generated by the drawing data generating section 22, raster (image) data may be converted into an engine resolution of the marking engine 30 and character (text) data and graphics may be converted into intermediate codes that may work well for the engine resolution and drawing data of the intermediate codes may be created. When generating drawing data, the drawing data generating section 22 attaches object tags to raster (image), character (text), and graphics data, according to command (step 107). The tags are attached to each pixel.

Here, when the printer system operates in normal mode, a text region is printed at, for example, 300 lines or less, taking account of color identification (gray scale). When the OCR mode is selected by the user, a text region is tagged to be printed at, for example, 600 lines or more, because jaggies impede encoding. Although screen lines are considered to be irrelevant, because the text region is saturated in the step 106, it may be a greater number of lines, since tone reduction control (TRC) for gray scale correction is performed at a later stage. While screening is performed by the screening section 25 in the engine controller 12 in the present exemplary embodiment, screening can be performed by the drawing data generating section 22 in the controller 11 for load distribution. Image data with tag data thus processed in the controller 11 is input to the engine controller 12.

The edge decision section 24 in the engine controller 12 performs edge extraction, using, for example, a 3×3 edge extraction filter (step 108). Here, for normal-mode processing, an edge portion is replaced by a 600-line tag, regardless of whatever object. The edge portion image data is modified by gamma y correction for 600 lines. At this time, a non-edge portion is skipped. The reason why edge decision is performed in addition to object separation is that some process may output characters to be read by the OCR as a raster image. Also, because the object decision is not always effective 100 percent, the edge decision is executed in combination with the object decision.

Here, when the OCR mode is selected, image data for an area (region) that is determined as an edge by the edge decision section 24 and has signals of 1/255 or more is saturated and its tag is replaced by a 600-line tag (step 109). The thus tagged image data is transferred to the screening section 25. Then, the screening section 25 performs screening according to tag (step 110). For example, an edge portion is screened with a 600-line screen and a non-edge portion is screened with an original screen (e.g., a 200-line screen for images, a 150-line screen for graphics, and a 300-line screen for characters). The screened image data is then input to the pulse width modulation section 26. The image data screened by the screening section 25 is modulated into pulse signals by the pulse width modulation section 26 and the pulse-width modulated image data is output to the marking engine 30 (step 111). Having received the image data, the marking engine 30 forms a color image on paper through the process by the components as shown in FIG. 1 and prints out the image (step 112).

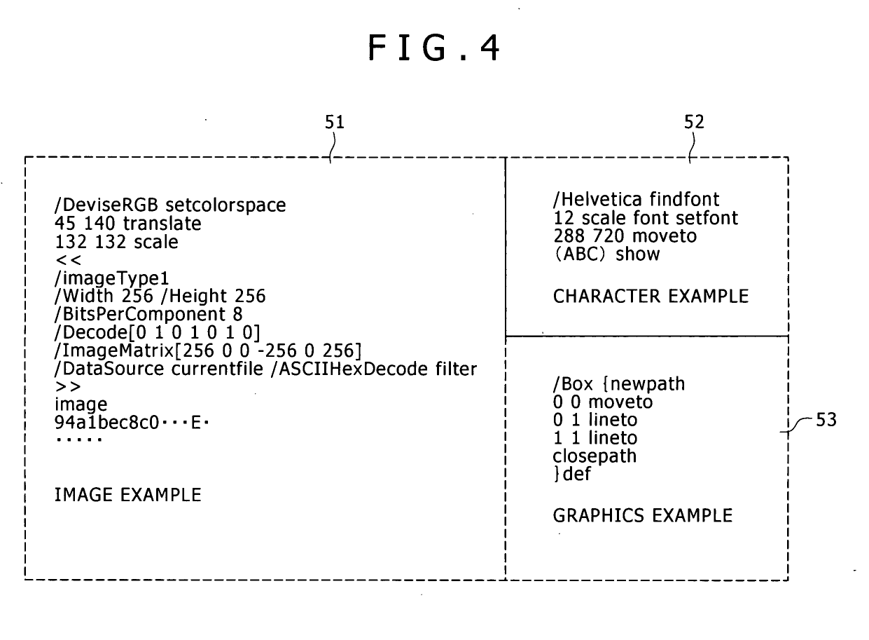

FIG. 4 shows an example of object separation from drawing commands described in a PostScript (a registered trademark) language. In FIG. 4, an image example 51, a character example 52, and a graphics example 53 are shown. Referring to the character example 52, the first description “/Helvetica findfont 12 scale font setfont” represents a font setting, where “/Helvetica” is the font name and “12” is the size of the character in units of points (in steps of 1/72 inch). The second description “288 720 moveto” specifies the position of the character, where the origin is the bottom left corner and the units are points (in steps of 1/72 inch). Here, “288” indicates the position on the X coordinate and “720” indicates the position on the Y coordinate. In the last description “(ABC) show”, a character string to be displayed is specified in the parentheses and “show” is a display command. The drawing data generating section 22 executes object separation according to these commands interpreted by the PDL interpreting section 21 (see step 104 in FIG. 3).

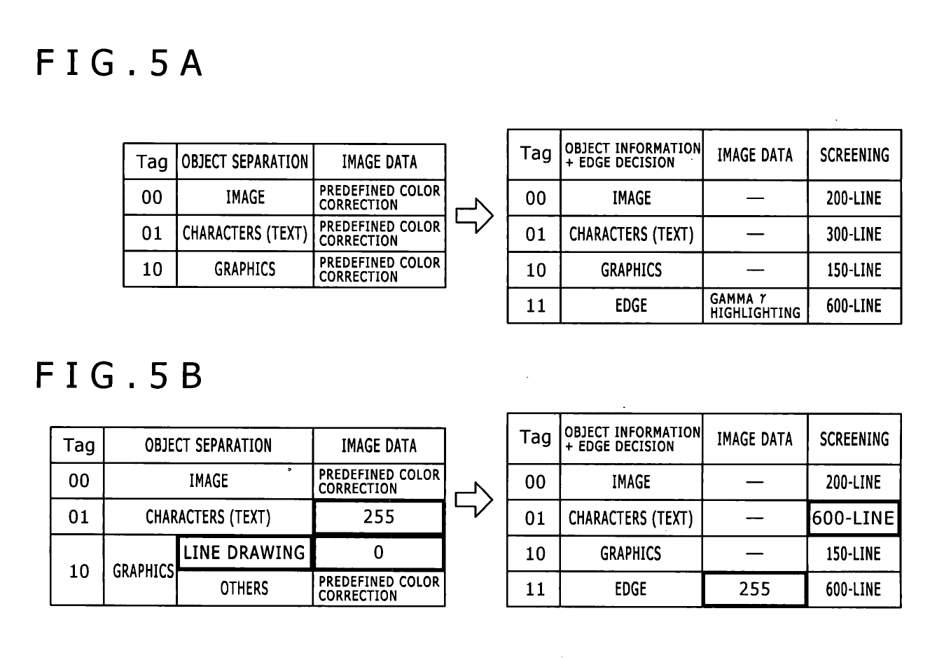

FIGS. 5A and 5B show examples of processing of each object according to tag. FIG. 5A exemplifies processing in normal mode and FIG. 5B exemplifies processing in OCR mode. In each figure, the left side of the arrow represents the processing at the controller 11 side and the right side of the arrow represents the processing at the engine controller 12 side. In the normal mode shown in FIG. 5A, as mentioned for step 107 in FIG. 3, tags 00, 01, 10 are attached to image, characters (text), graphics which are separated according to PDL commands, as exemplified in FIG. 4. In FIG. 5A, image data is subjected to predefined color correction. Further, at the engine controller 12 side shown in FIG. 5A, edge processing mentioned for step 108 in FIG. 3 is performed, and tag 11 is attached to the edge portion. This edge image data is subjected to gamma γ highlighting and screened by a 600-line screen, as noted above.

On the other hand, in the processing in OCR mode shown in FIG. 5B, the image signals in a character (text) region are saturated to 255, as mentioned for step 106 in FIG. 3. Also as mentioned in the step 106, the image signals in a region which is drawn by a drawing command, that is, the image signals constituting a line drawing portion of graphics are set below a predetermined density (for example, 0 (white)). At the engine controller 12 side, the edge processing mentioned for step 108 in FIG. 3 is performed likewise and tag 11 is attached to the edge portion. This edge portion image data is saturated to 255. The character (text) region is screened with a 600-line screen. Thereby, encoding can be made easy to do for the regions to be read or very likely to be read by the OCR processing.

As above, in the present exemplary embodiment, the OCR mode is adopted as a specific mode for outputting image data, assuming that the image data is scanned and encoded later. In this OCR mode, image manipulation (image enhancement) is performed on an image to be printed out so that subsequent encoding of the image can be performed successfully. In this image manipulation, edge extraction on a raster image supplied is executed and the image density of an edge portion is saturated. This enables correct encoding of light-color characters, for example. Also, in this image manipulation, object separation according to print command is performed and the data for a text region or an area for which a greater number of lines (600 lines or more) are specified can be replaced by a monotone black (100%). Furthermore, in this image manipulation, object separation according to print command is performed and the pixel density for a text region or an area for which a greater number of lines (600 lines or more) are specified can be saturated.

Moreover, in the present exemplary embodiment, object separation according to print command is performed and the pixel density for an area for which line drawing is specified is changed to be lowered and printed. In this image density adjustment, the density of line drawing is replaced by white (0%).

Here, it is also acceptable to replace the density of line drawing by a particular color such as, for example, blue or yellow, which is hard to read by a scanner. For control of the density of such line drawing, taking different manipulations according to line width is also effective. For example, lines within a form or the like may be replaced by white and table frames may be highlighted. Furthermore, object separation according to print command is performed and the image manipulation may also be configured such that an area where characters are superposed on the background is detected and the background color is replaced by white. In particular, if the contrast between the characters and the background is small, replacing the background by white is effective for correct encoding. Furthermore, the image manipulation may feature interpreting fonts and enlarging small marks such as punctuation and decimal points, dashes, periods, commas, etc. By thus emphasizing small marks, the rate of recognizing these marks can be improved and post-processing such as manual correction and the like after reading by OCR can be reduced. Especially, whether or not decimal points, punctuation, and commas can be discriminated and correctly read greatly influences the rate of recognition by OCR. Therefore, the significance of the present exemplary embodiment capable of greatly improving the rate of recognizing such marks is large.

In the OCR mode, it is also effective to print text information only at a greater number of lines and high gamma(Hi-γ), setting 2400 lines for characters only, 600 lines for line drawing, and 200 lines for halftone. This prevents crushed characters and enables OCR processing with an increased rate of recognition.

### SECOND EXEMPLARY EMBODIMENT

In the first exemplary embodiment, an image is enhanced by the image processing system 10 when it is printed out in order to facilitate OCR processing. The second exemplary embodiment is characterized in that print output for OCR is realized by, for example, font change at the client PC 2 and/or the image processing system 10. The same functions as in the first exemplary embodiment are identified by the same reference numbers and their detailed description is not repeated.

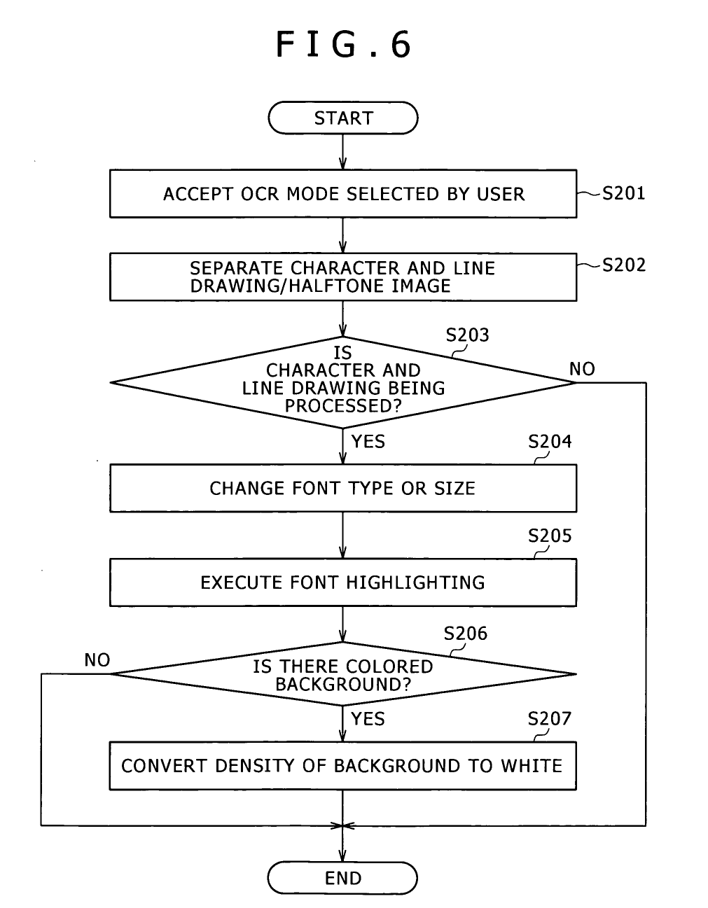

FIG. 6 is a flowchart illustrating the flow of processing in the OCR mode in the second exemplary embodiment. This process can be implemented by the application (printer driver) on the client PC 2 shown in FIG. 2 or the image processing system 10. First, the controller 11 in the image processing system 10 or the application on the client PC 2 recognizes OCR mode selected by the user (step 201). Separating image data for character and line drawing such as text (characters) and lines from halftone image data such as photographs is performed (step 202). This separation is performed according to a command, as exemplified in FIG. 4. As a result of the separation, it is determined whether character and line drawing is being processed (step 203). If not, this process terminates. If so, changing font type or font size is performed, for example, when converting the data for character and line drawing into raster data (step 204).

Font type change is, for example, to change to a bolder font than the usual one. For example, a Japanese mincho font may be forcedly changed to an Arial bold font and print the characters with the latter font. An example of incorrect recognition by OCR is faint characters. For example, the mincho font characters involve many fine line sections which are liable to cause faint characters. Thus, the mincho font characters and the like are converted into characters in a bold font not using fine lines and the latter characters are output. By thus printing characters with a font that is easy for OCR to recognize, it is possible to prevent the occurrence of a trouble in which faint lines occur in the fine line portions of the mincho font characters in print-outputting, resulting in incorrect recognition by OCR.

During OCR recognition, there is a possibility that light-color characters cannot be recognized because they are lower than a threshold for binarization. Accordingly, it is also effective to replace the color of color characters by black and output black characters.

Further, sometimes, characters of a font are too small relative to the scanner resolution and reading by OCR is not performed correctly. Accordingly, it is also acceptable to convert the font size of characters, for example, from 10 points to 14 points and output the latter size characters.

In addition to the font change in step 204 or alternatively, font highlighting is performed (step 205). The font highlighting may be underlining a set of characters to be read by OCR and extracting a set of characters to be read by OCR and changing them to red characters. If a set of characters to be read by OCR are known beforehand, such highlighting is performed on them. By reading a print image in which the above highlighting is performed and actually executing the OCR processing, the OCR reader will easily recognize a portion to be OCR processed. In consequence, the efficiency of the OCR processing can be enhanced.

Further, in addition to the above steps or alternatively, it is determined whether there is a colored background around the font (step 206). If not, the process terminates. If so, the density of the colored background is converted into a density lower than a predetermined density (e.g., white (0%)) (step 207) and the process terminates. By thus converting the density of the background into a density lower than a predetermined density (e.g., white (0%)), characters will be easy to read during OCR processing and a satisfactory result of OCR recognition can be obtained.

Font change and other manipulation for the data for character and line drawing that will be (is expected to be) processed by machine recognition after print-outputting can be made more effective by specifying the region of such characters beforehand in addition to specifying OCR mode, and printing out an image. For example, in a statement of accounts or the like, a region that requires OCR recognition is predetermined. Therefore, using a given application, by specifying a region so that printout in OCR mode can be executed for only the specified region, it is possible to further enhance the effect of the present exemplary embodiment.

As above, in the second exemplary embodiment, front change for characters data to be recognized by OCR is executed beforehand by the appropriate unit, for example, when converting the data for character and line drawing into raster data. Such font change may be, for example, to change the font to a bold font beforehand and to change the font size beforehand to a size that may help in reading by OCR. As font change or highlighting, underlining characters of a font or changing the color thereof is also effective. Moreover, for characters in a colored background, the density of the background is replaced by a density lower than a predetermined density (e.g., white (0%)). By thus embodying the invention, the auxiliary work of marking a region of interest with a marker as required in the above-discussed related art is dispensed with and incorrect recognition caused by a marking error can be prevented. Further, it is possible to enhance the rate of recognition by OCR without staining the original document.

As detailed above, in the present exemplary embodiments (the first and second exemplary embodiments), a concept of a high image quality when viewed from the OCR functionality, not a high image quality when viewed by human eyes, is introduced. Specifically, the OCR mode is adopted in which print output with a high image quality when viewed from the machine recognition function termed the OCR functionality can be achieved, whereas the print is not good in terms of an image quality when viewed by human eyes, for example. Furthermore, in other words, image data is printed on paper in the light of the rate of recognition by OCR. For image data that is to be processed by OCR after printed out, the image data is processed to have a high image quality when viewed from the OCR functionality, and this processing is triggered by, for example, recognizing OCR mode selected by the user. Thereby, the rate of recognition can be improved, when the machine recognition processing such as OCR processing is performed on the thus printed image, and increasing the OCR processing speed and the like can be achieved.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An image processing system that performs image processing on input image data, comprising:
an accepting part that accepts selection of a machine recognition processing mode intended for outputting a print image on the assumption that the image, after being output, is subjected to machine recognition processing; and
a processing part that performs specific image processing adapted for the machine recognition processing instead of normal image processing, when the selection of the machine recognition processing mode has been accepted by the accepting part.

2. The image processing system according to claim 1, wherein the machine recognition processing mode which is accepted by the accepting part is a mode on the assumption that the image, after being output, is subjected to Optical Character Reader (OCR) processing.

3. The image processing system according to claim 2, wherein the processing part manipulates a text portion for which the machine recognition processing is performed so that the text portion is easily recognized by the machine recognition.

4. The image processing system according to claim 3, wherein the processing part performs object separation according to a print command of the input image data and saturates an image density of a text portion separated by the object separation or replaces the image data for the text portion by 100% black.

5. The image processing system according to claim 2, wherein the processing part performs edge extraction if the input image data is a raster image, and saturates an image density of an edge portion extracted by the edge extraction, thereby successfully encoding low density characters.

6. The image processing system according to claim 1, wherein the processing part performs object separation according to a print command of the input image data and manipulates image data for an area of line drawing separated by the object separation so that lines in the area are hardly recognized by machine recognition.

7. The image processing system according to claim 6, wherein the processing part reduces a density for the area of the line drawing.

8. The image processing system according to claim 6, wherein the processing part replaces a color for the area of the line drawing by a color that is hardly read by a scanner.

9. An image processing system that performs image processing on character and line drawing information and outputs image data, comprising:
an input part that inputs character and line drawing information; and
a conversion part that converts, among the character and line drawing information entered by the input part, a font of the character and line drawing information which will be subject to machine recognition after print output into a specific font for the machine recognition processing.

10. The image processing system according to claim 9, further comprising an accepting part that accepts user selection of a machine recognition processing mode for print output for the machine recognition processing,
wherein the conversion part performs the font conversion, on the basis of the acceptance by the accepting part that characters will be subject to the machine recognition processing after the print output.

11. The image processing system according to claim 9, wherein the conversion part converts the font of the character and line drawing information into a bold font.

12. The image processing system according to claim 9, wherein the conversion part converts the font of the character and line drawing information into a size that is easily recognized by the machine recognition processing.

13. The image processing system according to claim 9, wherein the conversion part performs highlighting on the font of the character and line drawing information.

14. The image processing system according to claim 9, wherein the conversion part enlarges a size of small marks within the font to output enlarged marks.

15. The image processing system according to claim 9, further comprising a part that determines whether the entered character and line drawing information is placed in a colored background,
wherein, if it is determined that the character and line drawing information is placed in the colored background, a density of the colored background is reduced.

16. An image processing method that performs image processing on input image data, comprising:
entering selection of an OCR mode for outputting a print image on the assumption that the image, after being output, will be subject to OCR processing; and
performing specific image processing instead of normal image processing to make a text portion easily recognized during the OCR processing, when the selection of the OCR mode has been entered.

17. The image processing method according to claim 16, wherein the specific image processing converts a font of the text portion included in the input image data into a font that is easily recognized by the OCR processing and outputs font-converted characters.
